(19) United States
(12) Patent Application Publication
(10) Pub. No.: US 2018/0050841 A1
(43) Pub. Date: Feb. 22, 2018

(54) GRAVITY NOZZLE

(71) Applicant: PURPLE SERVICES, INC., Beverly Hills, CA (US)

(72) Inventors: Jean-Pierre HUBSCHMAN, Beverly Hills, CA (US); Tim Nugent, Venice, CA (US)

(21) Appl. No.: 15/240,724

(22) Filed: Aug. 18, 2016

(51) Int. Cl. B65D 25/48; B67D 7/04; B65D 25/30; B65D 47/06

(52) U.S. Cl. CPC B65D 25/48; B65D 47/06; B65D 25/30; B67D 7/04

(57) ABSTRACT

The present disclosure is directed to various embodiments of threaded container valves and gravity nozzles. The gravity nozzle includes a threaded container valve and a delivery tube. The threaded container valve includes a valve section having a first inlet and a second inlet, and an engagement section coupled to the valve section. The delivery tube includes a fluid tube and a vapor tube. The fluid tube has a first end, configured to engage with the first inlet of the valve section. The vapor tube has a first end, configured to engage with the second inlet of the valve section. The fluid tube and the vapor tube each have a second end, configured to engage with a delivery inlet.

This application is related to U.S. patent application Ser. No. 14/731,320, entitled “Device and System for Automotive Refueling”, filed Jun. 4, 2015, U.S. patent application Ser. No. 14/852,688, entitled “System and Fuel Nozzle for Vehicle Refueling”, filed Sep. 14, 2015, and U.S. patent application Ser. No. 15/162,054, entitled “Fluid Delivery Dolly”, filed May 23, 2016, the entire contents of which are incorporated herein by reference and relied upon.

### BACKGROUND

Fueling consumer vehicles can be a time consuming and labor intensive practice for the vehicle user. The current practice is for the user to (1) monitor the vehicle fuel level; (2) determine a low fuel condition; (3) locate a fueling station; (4) purchase fuel; (5) gain access to the fuel tank; and (6) manually service the fuel tank.

Other previously user labor intensive services have been streamlined using networked systems and smart phone technology. As an example, car service procurement typically requires the user to determine the need for a car, locate a car services' contact information, determine and communicate the desired pickup location, negotiate the type and amount of payment at the end of the service, and pay. This process has been streamlined to the point where the user simply launches a smart phone application and pushes a button to request the car service. The phone determines the location of pickup, which is utilized by the service to locate a nearby and available driver in the area and direct the driver to the corresponding pickup location. At the end of the service the payment to the driver is automatically taken care of by the service provider based on previous payment information provided by the user and a detailed receipt can be sent to the user.

This type of service streamlining is also desirable to enable fuel delivery services. One could consider a somewhat parallel approach to the car service procurement streamlining above. Similarly, for example, a smart phone application could allow a user to request fuel service at the touch of a button. The smart phone application would determine the location of the phone and transmit a request for fuel delivery to a fueling service. The fueling service would arrive at the location of the phone to service the vehicle fuel needs.

Payment could also be handled similarly to the car service procurement applications. However, to enable this in a way that is useful, various additional requirements that are specific to fuel delivery must be considered. Therefore, new systems and/or devices must be developed for this type of delivery service to function in a practical and useful way for the everyday consumer. For example, limited fuel service exists in some specific industries like construction or road side assistance. In those industries a fuel courier transports fuel to a location near the vehicle needing fuel and a person in the location (e.g., owner or driver of the vehicle) receives the fuel and provides delivery verification. This situation limits the convenience of the service, at least in part, because the person must wait to receive the fuel, identify to the courier the vehicle needing fuel and/or, in some events, dispense the fuel himself/herself out of a conventional container which can result in some hazards, including fuel leakage in both liquid and vapor forms. In addition, it is difficult and impractical for the requester to verify that the amount of fuel purchased was actually delivered and dispensed in the vehicle's fuel tank, that the fuel was not altered by the courier before it was dispensed (e.g., diluted), and that it is of the quality purchased (e.g., octane rating, etc.), due to the type of service.

Furthermore, in the event a fuel courier is transporting fuel in small quantities (e.g., a five gallon or other sized conventional portable fuel container, as opposed to a fuel truck), the transport of the portable fuel container can be hazardous. This includes transport within the fuel courier vehicle and transport from the fuel courier vehicle to the vehicle needing fuel. For example, fuel can leak from a portable fuel container in either liquid or vapor form, both of which are highly flammable. Likewise, for example, fuel can leak from a portable fuel container while being delivered (e.g., while being poured). This is especially relevant if the portable fuel container is rotated (e.g., rotated upside down) to facilitate pouring (e.g., gravity pouring). Thus, proper sealing of portable fuel containers is an important concern. Ideally, portable fuel containers should be optimally sealed during transport and during delivery, so as to limit inadvertent leakage in either liquid or vapor forms.

In view of the foregoing, new devices and systems are highly desirable in order to have a smart phone based fuel delivery service that works at the consumer level and in a practical, safe, and cost effective way. In particular, a system that can provide controlled delivery of fuel in an ergonomically and economically efficient manner, without requiring the customer, or a customer's representative, to be present at the time of delivery.

### SUMMARY

The present disclosure is directed to various embodiments of threaded container valves and gravity nozzles. In one embodiment, the threaded container valve includes a valve section, having a first inlet and a second inlet. Each of the first inlet and the second inlet are in fluid communication with a first side of the valve section and a second side of the valve section. The threaded container valve also includes an engagement section coupled to the valve section. The engagement section has an inner wall and an outer wall. The inner wall defines a thread profile configured to engage with a threaded container.

In another embodiment, the gravity nozzle includes a threaded container valve and a delivery tube. The threaded container valve includes a valve section, having a first inlet and a second inlet. Each of the first inlet and the second inlet are in fluid communication with a first side of the valve section and a second side of the valve section. The threaded container valve also includes an engagement section coupled to the valve section. The engagement section has an inner wall and an outer wall. The inner wall defines a thread profile configured to engage with a threaded container. The delivery tube includes a fluid tube and a vapor tube. A first end of the fluid tube is configured to engage with the first inlet on the first side of the valve section. A first end of the vapor tube is configured to engage with the second inlet on the first side of the valve section. A second end of the fluid tube and a second end of the vapor tube are configured to engage with a delivery inlet.

In particular embodiments, the threaded container valve and the gravity nozzle ensure proper sealing (e.g., configured to prevent fluid leakage and vapor leakage) on a container (e.g., a portable fuel container). For example, the threaded container valve and the gravity nozzle form a leak free system. This reduces health, safety, and environmental risks associated with leakage of particular substances (e.g., gasoline). Additionally, in particular embodiments, the threaded container valve and the gravity nozzle provide the user with the ability to unseal the container, and pour fluid from the container (e.g., a gravity pour) to an external location in a controlled manner. This further reduces risks associated with leakage of particular substances when handled by a user (e.g., during pouring).

Additional features and advantages are described herein, and will be apparent from the following Detailed Description and the Figures.

### BRIEF DESCRIPTION OF THE FIGURES

FIG. 1 illustrates a threaded container valve, according to an example embodiment of the present disclosure.

FIG. 2 illustrates an alternate view of the threaded container valve, according to an example embodiment of the present disclosure.

FIG. 3 illustrates an alternate cut-away view of the threaded container valve, according to an example embodiment of the present disclosure.

FIG. 4 illustrates a gravity nozzle, according to an example embodiment of the present disclosure.

FIG. 5 illustrates an alternate cut-away view of the gravity nozzle, according to an example embodiment of the present disclosure.

FIG. 6 illustrates an alternate cut-away view of the gravity nozzle, according to an example embodiment of the present disclosure.

FIG. 7 illustrates an alternate cut-away view of the gravity nozzle, according to an example embodiment of the present disclosure.

FIG. 8 illustrates a delivery tube, according to an example embodiment of the present disclosure.

FIG. 9 illustrates a flowchart of a method of using a gravity nozzle, according to an example embodiment of the present disclosure.

### DETAILED DESCRIPTION

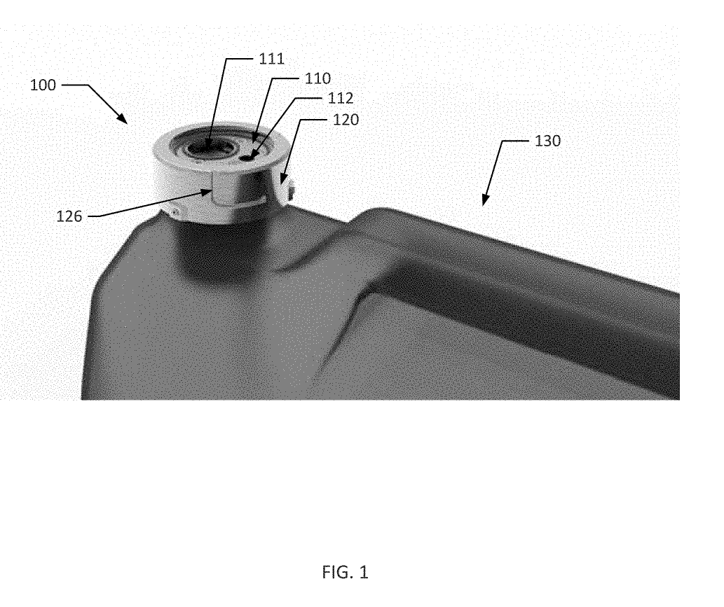

FIG. 1 illustrates an example embodiment of a threaded container valve. The threaded container valve 100 includes a valve section 110 and an engagement section 120. In an embodiment, the engagement section 120 is coupled to the valve section 110. In a different embodiment, the valve section 110 and the engagement section 120 are formed of a single piece of material, which collectively form the threaded container valve 100. The threaded container valve 100 is generally configured to engage with a threaded container 130. For example, by engaging with the threaded container 130, the threaded container valve 100 seals the threaded container 130.

In one non-limiting example, the threaded container 130 is a portable fuel container. In one such example, the threaded container 130 is a 5-gallon capacity portable fuel container. It should be noted, however, that the threaded container 130 as discussed herein is in no way limited to certain fluid contents nor limited to any particular size. For example, threaded containers (e.g., threaded container 130) may be configured to hold any type of substance including a liquid (e.g., water), gel (e.g., lubricant), solid (e.g., sand), etc. and may be any size (e.g., 1-liter, 5-gallon, 10-gallon, 55-gallon, etc.). In various examples, the threaded container 130 may be plastic or metal.

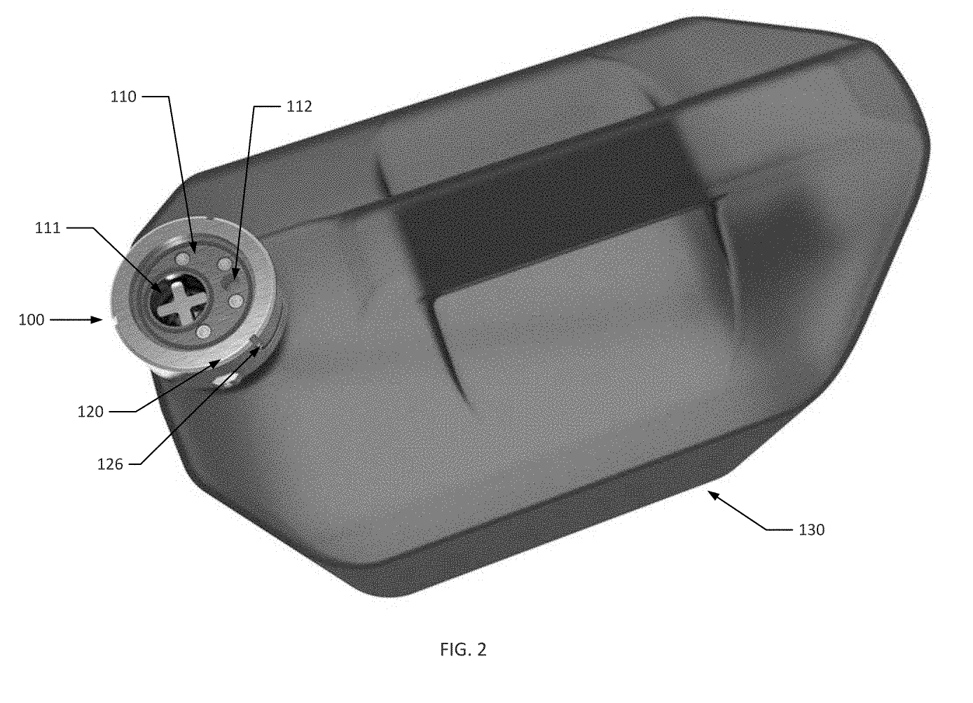

The valve section 110 of the threaded container valve 100 additionally includes a first inlet 111 and a second inlet 112. FIG. 2 illustrates an alternate view of an example embodiment of the threaded container valve 100, with the first inlet 111 and the second inlet 112. In an example embodiment, the threaded container valve 100 further includes a removable cap (not shown). For example, the removable cap may be a circular plastic cap, rubber stopper, etc. The removable cap may interface with the valve section 110 of the threaded container valve 100. In one example, the removable cap interfaces with the valve section 110 by snap-fitting to the valve section 110. For example, the valve section 110 may include a raised edge, defining a circumference larger than a circumference of the removable cap, such that the removable cap snap-fits inside the circumference defined by the raised edge of the valve section 110. In a different related example, the removable cap interfaces with the engagement section 120 by snap-fitting to the engagement section 120 in a similar way. In a second example, the removable cap interfaces with the valve section 110 via a thread-profile. For example, the removable cap may include threads and the valve section 110 may include the raised edge with a thread profile, such that the removable cap fits inside or around the raised edge and engages with the valve section 110 via its thread profile.

By interfacing with the valve section 110, the removable cap may form an additional seal over the first inlet 111 and the second inlet 112. Forming an additional seal may further ensure that fluid and vapor do not leak from the threaded container 130 when the threaded container valve 100 is not being used for fluid delivery, as described herein (e.g., no undesirable gasoline leakage from the threaded container 130 during long term storage or transportation).

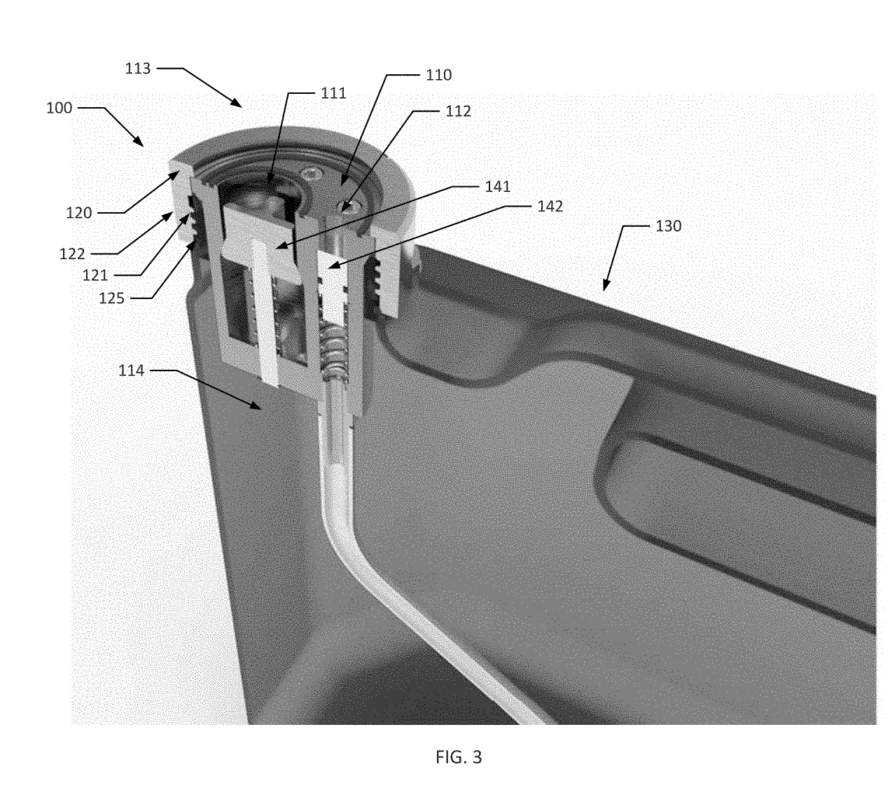

FIG. 3 illustrates an alternate cut-away view of an example embodiment of the threaded container valve 100. As previously noted, the valve section 110 includes the first inlet 111 and the second inlet 112. Each of the first inlet 111 and the second inlet 112 are in fluid communication with a first side 113 of the valve section 110 and a second side 114 of the valve section 110. In an example, the first side 113 of the valve section 110 is a location external to the threaded container 130 (e.g., outside the threaded container 130). Likewise, in an example, the second side 114 of the valve section 110 is a location internal to the threaded container 130 (e.g., inside the threaded container 130).

The engagement section 120 has an inner wall 121 and an outer wall 122. For example, the inner wall 121 defines a thread profile 125, which is configured to engage with the threaded container 130. In this way, the threaded container valve 100 engages with the threaded container 130 to seal the threaded container 130. For example, the threaded container valve 100 is rotated around the threaded container 130 at the inlet of the threaded container 130 to form the seal. Sealing of the threaded container 130 is particularly challenging because, often, threaded containers 130 (e.g., portable fuel containers) are blow-molded (e.g., having non-uniform walls). Sealing the threaded container 130 is difficult when the threads or rim of the threaded container 130 are, likewise, non-uniform. Therefore, in some embodiments the threaded container valve 100 (e.g., the thread profile 125 on the inner wall 121 of the engagement section 120 of the threaded container valve 100) may implement an o-ring or other type of gasket. Implementation of an o-ring or other type of gasket may improve sealing characteristics between the threaded container valve 100 and the threaded container 130. In an alternate example, the outer wall 122 of the engagement section 120 defines the thread profile 125, such that the threaded container valve 100 may engage with the threaded container 130 when the threaded container has internal threads. For example, the threaded container valve 100 is rotated inside the threaded container 130 at the inlet of the threaded container 130 to form the seal.

The threaded container valve 100 further includes a first sealing member 141 and a second sealing member 142. The first sealing member 141 concentrically engages with the first inlet 111. The second sealing member 142 concentrically engages with the second inlet 112. In one non-limiting example, each of the components discussed herein (e.g., the valve section 110, the engagement section 120, the first sealing member 141, the second sealing member 142, etc.) are composed of aluminum. In a different example, each of the components discussed herein are composed of other metals (e.g., stainless steel, tungsten, etc.) or other suitable materials (e.g., glass, plastic, etc.) designed to resist corrosion by particular fluids (e.g., gasoline). Likewise, in another different example, some components may be made of one material (e.g., aluminum), whereas other components may be made of other materials (e.g., stainless steel). For example, the valve section 110 may be made of aluminum, while the first sealing member 141 and the second sealing member 142 may be made of stainless steel.

In an embodiment, the first sealing member 141 and the second sealing member 142 are spring-biased mechanical seals. In an embodiment, each of the first sealing member 141 and the second sealing member 142 have multiple positions of operation. For example, the first sealing member 141 and the second sealing member 142 each have an open position and a closed position. In an embodiment, each of the first sealing member 141 and the second sealing member 142 are biased (e.g., spring-biased) in the closed position, such that the first sealing member 141 and the second sealing member 142 prevent fluid communication within their respective inlets. For example, the first sealing member 141 prevents fluid communication within the first inlet 111, between the first side 113 of the valve section 110 and the second side 114 of the valve section 110. Likewise, for example, the second sealing member 142 prevents fluid communication within the second inlet 112, between the first side 113 of the valve section 110 and the second side 114 of the valve section 110. As illustrated in FIG. 3, each of the first sealing member 141 and the second sealing member 142 are biased in the closed position.

In an embodiment, each of the first sealing member 141 and the second sealing member 142 are configured to be placed in the open position upon actuation by a mechanical force. By being placed in the open position, each of the first sealing member 141 and the second sealing member 142 may permit fluid communication within their respective inlets. For example, once opened, the first sealing member 141 permits fluid communication within the first inlet 111, between the first side 113 of the valve section 110 and the second side 114 of the valve section 110. Likewise, for example, once opened, the second sealing member 142 permits fluid communication within the second inlet 112, between the first side 113 of the valve section 110 and the second side 114 of the valve section 110. In an embodiment, the mechanical force is generated by a first end of a delivery tube.

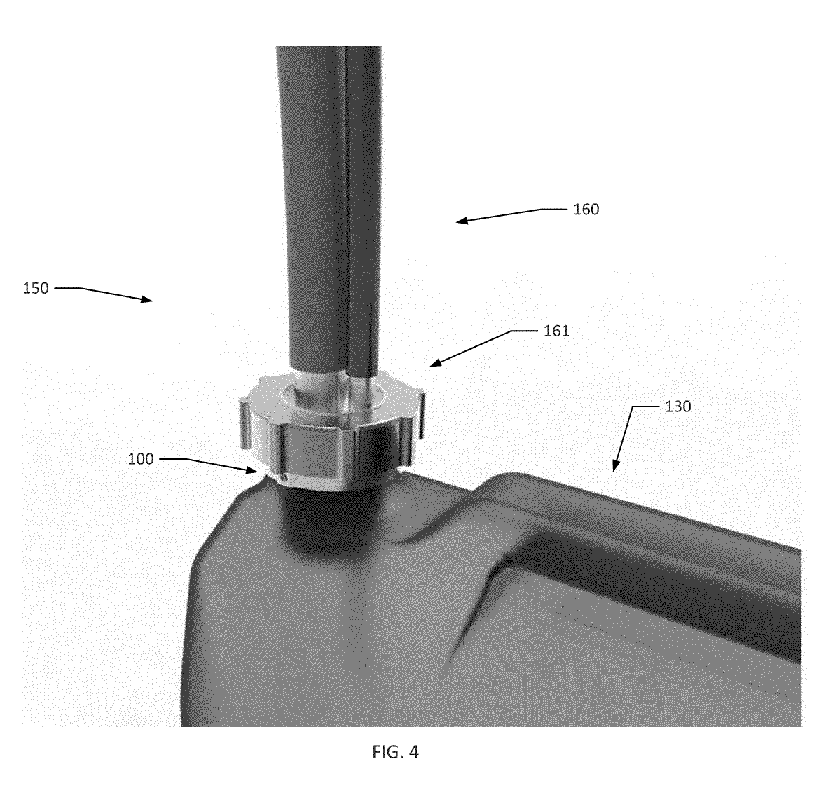

For example, as illustrated by FIG. 4, the first end 161 of the delivery tube 160 engages with the valve section 110 of the threaded container valve 100, on the first side 113 of the valve section 110. By including the delivery tube 160 (e.g., via delivery tube 160 engagement with the valve section 110 of the threaded container valve 100), the delivery tube 160 and the threaded container valve 100 may be collectively referred to as a gravity nozzle 150.

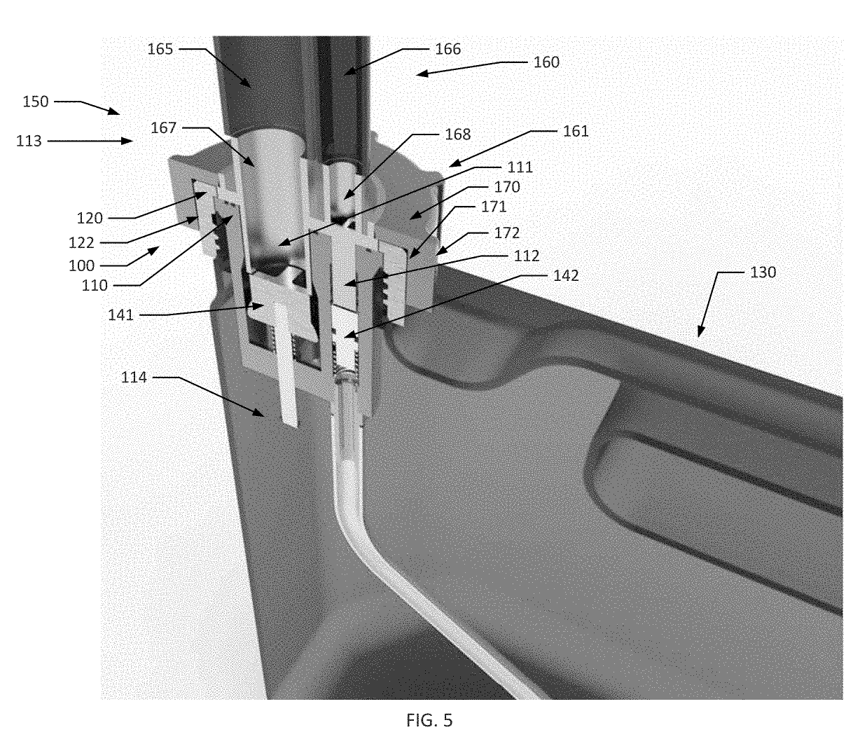

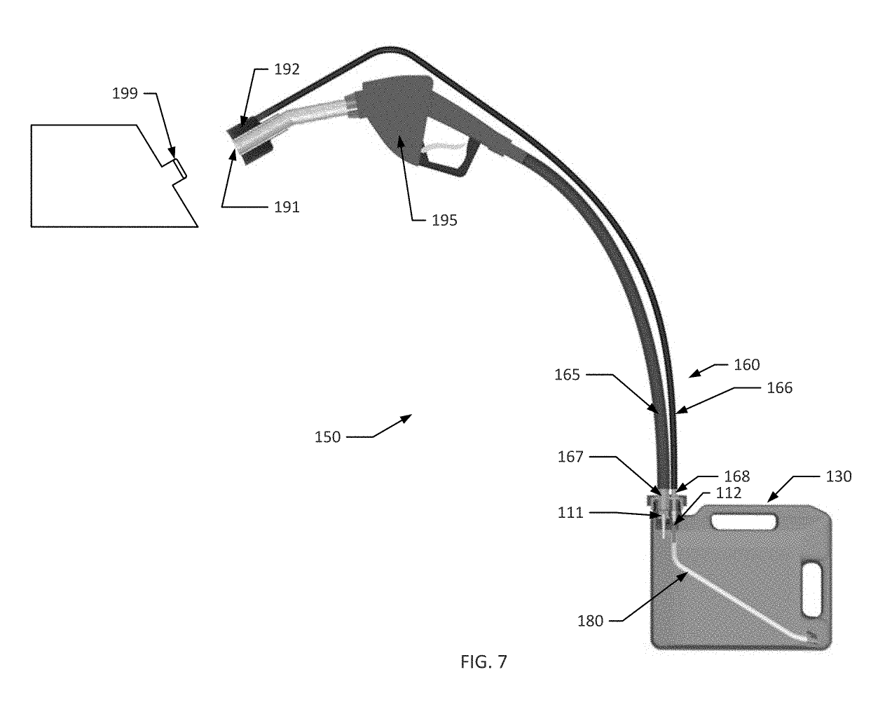

FIG. 5 illustrates an alternate cut-away view of an example embodiment of the gravity nozzle 150. The gravity nozzle 150 includes the threaded container valve 100, which includes the valve section 110 and the engagement section 120 as described in detail above with respect to FIGS. 1 to 3. The gravity nozzle further includes the delivery tube 160. The delivery tube 160 includes a fluid tube 165 and a vapor tube 166. A first end 167 of the fluid tube 165 is configured to engage with the first inlet 111 on the first side 113 of the valve section 110. A first end 168 of the vapor tube 166 is configured to engage with the second inlet 112 on the first side 113 of the valve section 110. A second end of the fluid tube 165 (not shown) and a second end of the vapor tube 166 (not shown) are configured to engage with a delivery inlet (not shown), as described in greater detail below with reference to FIGS. 7 to 9.

As noted previously, in an embodiment, each of the first sealing member 141 and the second sealing member 142 are configured to be placed in the open position upon actuation by a mechanical force (e.g., the first end 161 of the delivery tube 160 engaging with the valve section 110 on the first side 113 of the valve section 110). For example, the first end 167 of the fluid tube 165 is configured to engage with the first inlet 111 on the first side 113 of the valve section 110 (e.g., concentric engagement), such that the first sealing member 141 is placed in the open position. Likewise, for example, the first end 168 of the vapor tube 166 is configured to engage with the second inlet 112 on the first side 113 of the valve section 110 (e.g., concentric engagement), such that the second sealing member 142 is placed in the open position. Each of the first sealing member 141 and the second sealing member 142 may be configured to have appropriate spring-biasing, such that an optimum force (e.g., manual actuation by a person) will place each of the first sealing member 141 and the second sealing member 142 in the open position. As illustrated in FIG. 5, each of the first sealing member 141 and the second sealing member 142 are in the open position.

With reference to FIGS. 1 and 5, in an embodiment, the delivery tube 160 further includes a cap section 170 coupled to the first end 161 of the delivery tube 160. The cap section 170 has an inner wall 171 and an outer wall 172.

In an example, the inner wall 171 of the cap section 170 additionally has a notch (not shown). The outer wall 122 of the engagement section 120 has a groove 126 (as shown in FIG. 1). The groove 126 is configured to receive the notch from the cap section 170, such that a seal is formed between the outer wall 122 of the engagement section 120 and the inner wall 171 of the cap section 170 when the notch is received by the groove 126. The notch may be received by the groove 126 via a downward force of the cap section 170, followed by a rotation of the cap section 170 (e.g., one-quarter turn). In an alternate embodiment, the relative positions of the groove 126 and the notch may be switched, such that the groove 126 is positioned on the inner wall 171 of the cap section 170 and the notch is positioned on the outer wall 122 of the engagement section 120. In an embodiment, forming a seal between the outer wall 122 of the engagement section 120 and the inner wall 171 of the cap section 170, when the notch is received by the groove 126, ensures that the delivery tube 160 does not inadvertently disengage from the valve section 110 on the first side 113 of the valve section 110.

In alternate examples, the cap section 170 may engage with the engagement section 120 of the threaded container valve 100 in other ways. For example, the cap section 170 may snap-fit to the engagement section 120 of the threaded container valve 100. For example, the engagement section 120 may include a raised edge, defining a circumference larger than an inner groove on the inner wall 171 of the cap section 170, such that the cap section 170 snap-fits around the engagement section 120 when the raised edge of the engagement section 120 snaps into the inner groove on the inner wall 171. In an alternate embodiment, the relative positions of the groove and the raised edge are switched.

In a second alternate example, the cap section 170 may engage with the engagement section 120 of the threaded container valve 100 via a thread-profile. For example, the cap section 170 may include threads (e.g., threads on the inner wall 171 of the cap section). Likewise, for example, the engagement section 120 may include threads (e.g., threads on the outer wall 122 of the engagement section 120). The cap section 170 may rotate about the engagement section 120, such that the threads of the inner wall 171 of the cap section 170 engage the threads of the outer wall 122 of the engagement section. In a related example, the cap section 170 may rotate about the delivery tube 160. For example, the cap section 170 may rotate (e.g., rotate for engagement via threads) while the delivery tube (e.g., both the fluid tube 165 and the vapor tube 166) remain fixed (e.g., do not rotate).

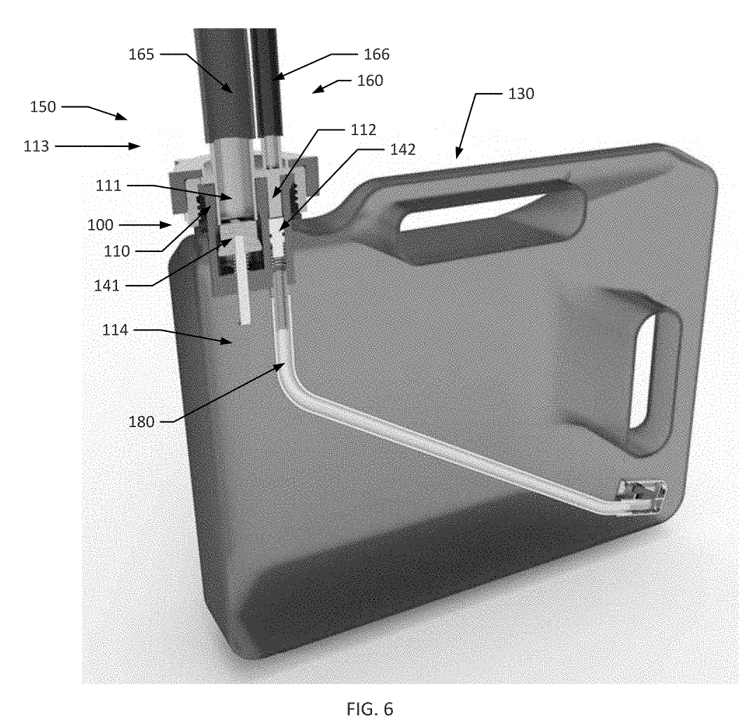

FIG. 6 illustrates an alternate cut-away view of an example embodiment of the gravity nozzle 150. In an embodiment, the first inlet 111 is configured for liquid flow between the first side 113 of the valve section 110 and the second side 114 of the valve section 110. Likewise, in an embodiment, the second inlet 112 is configured for vapor flow between the first side 113 of the valve section 110 and the second side 114 of the valve section 110.

In a related embodiment, the second inlet 112 includes a vapor tube extension 180. The vapor tube extension 180 is in fluid communication with the second inlet 112. The vapor tube extension 180 extends beyond the second inlet 112 on the second side 114 of the valve section 110. For example, the vapor tube extension 180 extends inside the threaded container 130 to increase a pressure differential between fluid exiting the threaded container 130 (e.g., via the first inlet 111) and recovered vapor entering the threaded container 130 (e.g., via the second inlet 112), as described in greater detail below. The vapor tube extension 180 may include a low-pressure ball check valve to eliminate undesired fluid from entering into the vapor tube extension 180.

In an alternate embodiment, the gravity nozzle 150 is configured solely for liquid flow. For example, the valve section 110 has a first inlet 111 configured for liquid flow between the first side 113 of the valve section 110 and the second side 114 of the valve section 110. However, in this alternate embodiment, the valve section 110 does not include the second inlet 112. Rather, any vapor transmission between the first side 113 of the valve section 110 and the second side 114 of the valve section must pass through the first inlet 111. In another alternate embodiment, the valve section 110 has more than two inlets. For example, the valve section 110 may have a first inlet 111 configured for liquid flow, a second inlet 112 configured for vapor flow, and a third inlet. In various examples, the third inlet may be configured for liquid flow, vapor flow, or both types of flow.

FIG. 7 illustrates an alternate cut-away view of an example embodiment of the gravity nozzle 150. The fluid tube 165 has a second end 191. Likewise, the vapor tube 166 has a second end 192. In an embodiment, the second end 191 of the fluid tube 165 and the second end 192 of the vapor tube 166 are configured to engage with a delivery inlet 199. For example, the delivery inlet 199 may be the opening of a tank or container. In an embodiment, the delivery inlet 199 is a gas tank on a car.

As shown in FIG. 7, the second end 192 of the vapor tube 166 is configured concentrically around an outside of the second end 191 of the fluid tube 165. In this configuration, the second end 191 of the fluid tube 165 may concentrically engage with the delivery inlet 199 by extending into the delivery inlet 199. For example, the diameter of the second end 191 of the fluid tube 165 is less than the diameter of the delivery inlet 199. Likewise, in this configuration, the second end 192 of the vapor tube 166 may concentrically engage with the delivery inlet 199 by surrounding the delivery inlet 199. For example, the diameter of the second end 192 of the vapor tube 166 is greater than the diameter of the delivery inlet 199. Through this concentric engagement, the second end 192 of the vapor tube 166 is configured for vapor recovery from the delivery inlet 199. Vapor recovery is especially desirable with fluids that evaporate quickly (e.g., gasoline). Vapor recovery ensures that vapor is not inadvertently released into the air, thus improving safety and environmental risks associated with handling of particular fluids (e.g., pouring gasoline). Additionally, vapor recovery ensures that vapor is not wasted (e.g., vapor can be recovered and subsequently condensed into a pourable liquid form).

In a related embodiment, the first end 167 of the fluid tube 165 engages the first inlet 111 of the valve section 110. Likewise, the first end 168 of the vapor tube 166 engages the second inlet 112 of the valve section 110. In this way, a fluid circuit is formed. For example, the fluid circuit is formed from the delivery inlet 199, through the vapor tube 166 (e.g., from the second end 192 of the vapor tube 166 to the first end 168 of the vapor tube 166), through the second inlet 112 (and the corresponding vapor tube extension 180), into the threaded container 130, through the first inlet 112, through the fluid tube (e.g., from the first end 167 of the fluid tube 165 to the second end 191 of the fluid tube 165), and back to the delivery inlet 199.

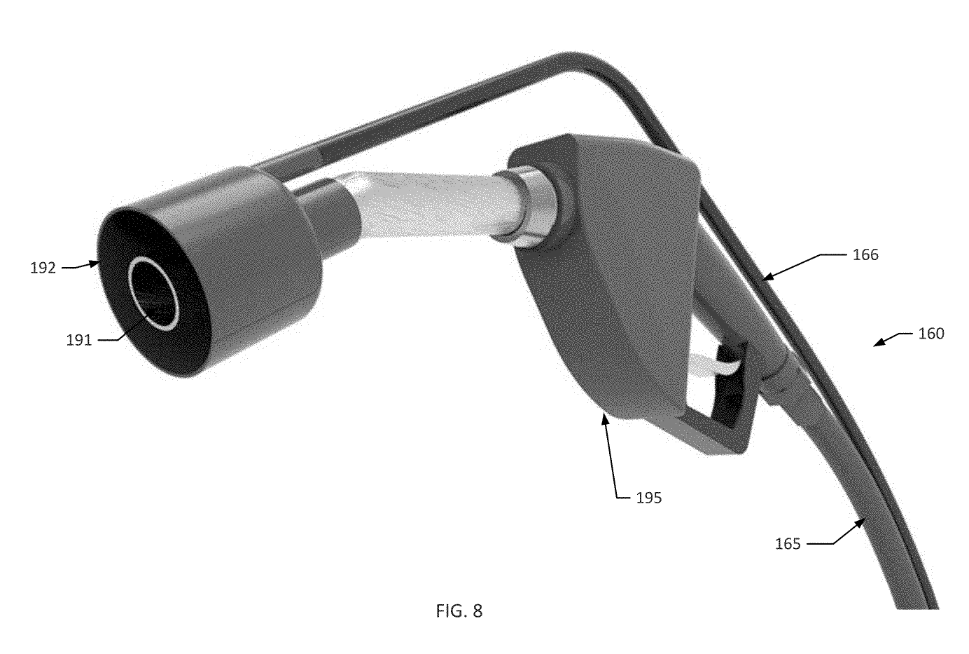

FIG. 8 illustrates an example embodiment of the delivery tube 160. For example, as previously described, the second end 192 of the vapor tube 166 is configured concentrically around an outside of the second end 191 of the fluid tube 165. In this configuration, the second end 191 of the fluid tube 165 concentrically engages with the delivery inlet 199 by extending into the delivery inlet 199, whereas the second end 192 of the vapor tube 166 concentrically engages with the delivery inlet 199 by surrounding the delivery inlet 199. Thus, vapor recovery is inherently built-in to the delivery tube 160.

In an embodiment, the delivery tube 160 further includes a control valve 195. For example, the control valve 195 may be configured to regulate the flow rate of fluid through the fluid tube 165. In various embodiments, the control valve may be a ball valve or any other type of fluid flow valve configured to regulate fluid flow. In a related embodiment, the control valve 195 further includes a sensor, configured to monitor the volume of fluid dispensed through the fluid tube 165, volumetric flow rate, etc. In other examples, the control valve 195 may include alternate or additional features. For example, the control valve 195 may include a shutdown feature, which may be triggered upon detection of a “full” condition at the delivery inlet 199. In this example, the control valve may communicate with additional sensors positioned, for example, at the second end 191 of the fluid tube 165. Likewise, for example, the control valve 195 may include a visual indication of fill level (e.g., empty, half-full, full, 25% full, 60% full, 99% full, etc.) via a mechanical gage, electro-mechanical sensor, LCD display, LED display, etc. The control valve 195 may communicate measured information (e.g., volume of fluid dispensed, volumetric flow rate, fill level, etc.) with internal components (e.g., a processor, memory, etc.) and/or external components (e.g., an external network, a user's cell phone, an automobile, etc.)

In another embodiment, the delivery tube 160 may be dimensioned for a desired fluid flow rate. For example, each of the fluid tube 165 and the vapor tube 166 (and the corresponding first inlet 111 and second inlet 112) may be configured with appropriate cross-sections, such that fluid will flow, via gravity, through the fluid tube 165 at a desired rate (e.g., 1 gallon per minute, 2 gallons per minute, etc.). In this way, basic fluid mechanics and delivery requirements may dictate the appropriate dimensioning of the fluid tube 165, the vapor tube 166, and the gravity nozzle 150 generally.

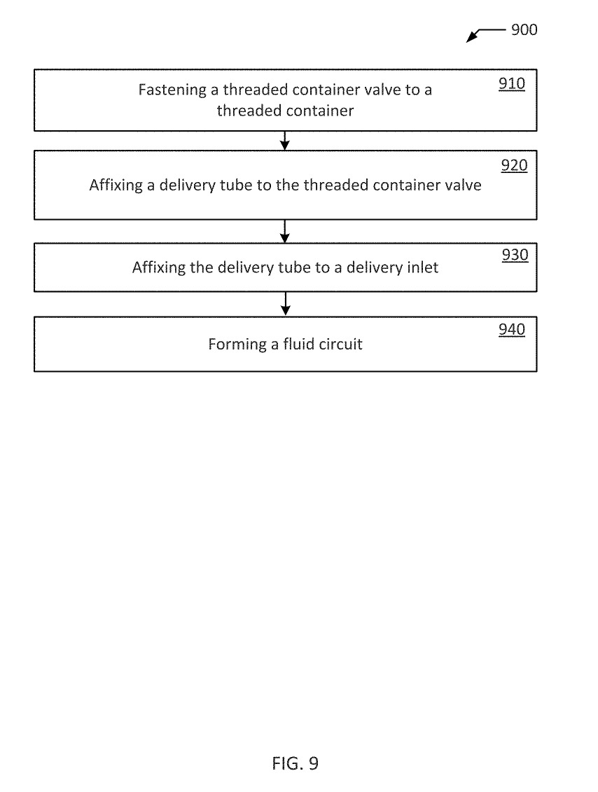

FIG. 9 illustrates a flowchart of a method of using a gravity nozzle 150, according to an example embodiment of the present disclosure. The method 900 includes a first step 910 of fastening a threaded container valve 100 to a threaded container 130. In an example embodiment, the threaded container valve 100 has an inner wall 121 and an outer wall 122. The inner wall 121 defines a thread profile 125 configured to engage with the threaded container 130. The threaded container valve 100 additionally has a first inlet 111 and a second inlet 112.

The method 900 includes a second step 920 of affixing a delivery tube 160 to the threaded container valve 100. In one embodiment, the second step 920 initially requires removing the removable cap from the valve section 110 (as described above with reference to FIG. 2). In an example embodiment, the delivery tube 160 includes a cap section 170 with a notch. The notch is configured to be received by a groove 126 on the outer wall 122 of the threaded container 130. The delivery tube 160 includes a first end 167 of a fluid tube 165 concentrically engaged with the first inlet 111. The delivery tube 160 further includes a first end 168 of a vapor tube 166 concentrically engaged with the second inlet 112.

The method 900 includes a third step 930 of affixing the delivery tube 160 to a delivery inlet 199. In an example embodiment, a second end 192 of the vapor tube 166 is configured concentrically around an outside of a second end 191 of the fluid tube 165. The second end 191 of the fluid tube 165 concentrically engages with the delivery inlet 199 by extending into the delivery inlet 199. The second end 192 of the vapor tube 166 concentrically engages with the delivery inlet 199 by surrounding the delivery inlet 199.

The method 900 includes a fourth step 940 of forming a fluid circuit. In an example embodiment, the fluid circuit is formed from the delivery inlet 199, through the vapor tube 166, through the second inlet 112, into the threaded container 130, through the first inlet 111, through the fluid tube 165, and back to the delivery inlet 199.

For example, by implementing the method 900 described above, a courier may form a complete fluid circuit between a first location (e.g., the threaded container 130) and a second location (e.g., the delivery inlet 199). Through formation of a complete fluid circuit, fluid may be transferred from the first location to the second location with minimal leakage. For example, the threaded container 130 may be inverted, such that the threaded container valve 100 is below a liquid level within the threaded container 130. Because the threaded container valve 100 forms a seal with the threaded container 130 (as discussed above with respect to FIG. 3) fluid leakage is reduced. Likewise, due to vapor recapture at the second end 192 of the vapor tube 166 (as discussed above with respect to FIG. 7), vapor leakage is reduced. Once the threaded container 130 is inverted, fluid may flow from the threaded container 130, through the first inlet 111, and through the fluid tube 165 to the delivery inlet 199. This assumes that the threaded container 130 is above the vertical location of the delivery inlet (e.g., circumstances facilitating gravity pouring). Likewise, escaping vapor near the delivery inlet 199 may be captured by the vapor tube 166, and transmitted back to the threaded container 130 through the second inlet 112. Additionally, beyond vapor recapture, the vapor tube 166 and second inlet 112 allow for pressure balancing within the threaded container valve 130. For example, the vapor tube 166 and the second inlet 112 improve flow consistency (e.g., laminar flow) of the fluid exiting the first inlet 111.

In a preferred embodiment, the fluid transferred from the first location to the second location is gasoline. For example, the courier, by implementing the method 900 described above, pours gasoline from a portable fuel container (e.g., the threaded container 130) to a car's gas tank (e.g., the delivery inlet 199) in a safe and efficient manner.

The threaded container valves and gravity nozzles as described herein may be related to additional components for fluid delivery. For example, the threaded container valves and gravity nozzles may be used in tandem with a smart fueling pump/nozzle and system, as illustrated by U.S. patent application Ser. No. 14/852,688, “System and Fuel Nozzle for Vehicle Refueling”, incorporated herein by reference. Likewise, for example, the threaded container valves and gravity nozzles may be used in tandem with additional devices and systems, such as smart fuel caps, vehicle mounted electronic dongles, order fulfillment applications, etc., as illustrated by U.S. patent application Ser. No. 14/731,320, “Device and System for Automotive Refueling”, incorporated herein by reference. Likewise, for example, the threaded container valves and gravity nozzles may be used with a fluid delivery dolly, as illustrated by U.S. patent application Ser. No. 15/162,054, “Fluid Delivery Dolly”, incorporated herein by reference.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A threaded container valve comprising:
a valve section having a first inlet and a second inlet, wherein each of the first inlet and the second inlet are in fluid communication with a first side of the valve section and a second side of the valve section; and
an engagement section coupled to the valve section, the engagement section having an inner wall and an outer wall, the inner wall defining a thread profile configured to engage with a threaded container.

2. The threaded container valve of claim 1, wherein a first sealing member concentrically engages with the first inlet and a second sealing member concentrically engages with the second inlet.

3. The threaded container valve of claim 2, wherein the first sealing member and second sealing member are spring-biased mechanical seals.

4. The threaded container valve of claim 2, wherein each of the first sealing member and the second sealing member have an open position and a closed position, and wherein each of the first sealing member and the second sealing member are biased in the closed position, such that the first sealing member and the second sealing member prevent fluid communication between the first side of the valve section and the second side of the valve section.

5. The threaded container valve of claim 4, wherein the first sealing member and the second sealing member are configured to be placed in the open position upon actuation by a mechanical force, such that the first sealing member and the second sealing member permit fluid communication between the first side of the valve section and the second side of the valve section.

6. The threaded container valve of claim 5, wherein the mechanical force is generated by a first end of a delivery tube engaging with the valve section on the first side of the valve section, wherein the delivery tube includes:
a fluid tube, wherein a first end of the fluid tube is configured to engage with the first inlet of the valve section, such that the first sealing member is placed in the open position, and
a vapor tube, wherein a first end of the vapor tube is configured to engage with the second inlet of the valve section, such that the second sealing member is placed in the open position.

7. The threaded container valve of claim 6, wherein the first end of the fluid tube concentrically engages the first inlet of the valve section, and wherein the first end of the vapor tube concentrically engages the second inlet of the valve section.

8. The threaded container valve of claim 6, wherein the delivery tube further includes a cap section coupled to the first end of the delivery tube, the cap section having an inner wall and an outer wall, wherein the inner wall of the cap section has a notch, and wherein the outer wall of the engagement section has a groove configured to receive the notch, such that a seal is formed between the outer wall of the engagement section and the inner wall of the cap section when the notch is received by the groove.

9. The threaded container valve of claim 6, wherein a second end of the fluid tube and a second end of the vapor tube are configured to engage with a delivery inlet.

10. The threaded container valve of claim 9, wherein the delivery inlet is a gas tank on a car.

11. The threaded container valve of claim 1, wherein the first inlet is configured for liquid flow between the first side of the valve section and the second side of the valve section.

12. The threaded container valve of claim 1, wherein the second inlet is configured for vapor flow between the first side of the valve section and the second side of the valve section.

13. The threaded container valve of claim 12, wherein the second inlet includes a vapor tube extension in fluid communication with the second inlet, the vapor tube extension extending beyond the second inlet on the second side of the valve section.

14. A gravity nozzle comprising:
a threaded container valve, the threaded container valve comprising:
a valve section having a first inlet and a second inlet, wherein each of the first inlet and the second inlet are in fluid communication with a first side of the valve section and a second side of the valve section, and
an engagement section coupled to the valve section, the engagement section having an inner wall and an outer wall, the inner wall defining a thread profile configured to engage with a threaded container; and
a delivery tube, the delivery tube comprising:
a fluid tube, wherein a first end of the fluid tube is configured to engage with the first inlet on the first side of the valve section, and
a vapor tube, wherein a first end of the vapor tube is configured to engage with the second inlet on the first side of the valve section,
wherein a second end of the fluid tube and a second end of the vapor tube are configured to engage with a delivery inlet.

15. The gravity nozzle of claim 14, wherein the threaded container is a fluid container such that, by the threaded container valve engaging with the threaded container, the threaded container valve seals the fluid container.

16. The gravity nozzle of claim 15, wherein the first end of the fluid tube engages the first inlet of the valve section and the first end of the vapor tube engages the second inlet of the valve section, such that a fluid circuit is formed from the delivery inlet, through the vapor tube, through the second inlet, into the fluid container, through the first inlet, through the fluid tube, and back to the delivery inlet.

17. The gravity nozzle of claim 14, wherein the second end of the vapor tube is configured concentrically around an outside of the second end of the fluid tube, wherein the second end of the fluid tube concentrically engages with the delivery inlet by extending into the delivery inlet, and wherein the second end of the vapor tube concentrically engages with the delivery inlet by surrounding the delivery inlet.

18. The gravity nozzle of claim 14, wherein the delivery tube further includes a control valve, the control valve configured to regulate the flow rate of fluid through the fluid tube.

19. The gravity nozzle of claim 18, wherein the control valve further includes a sensor, the sensor configured to monitor a volume of fluid dispensed through the fluid tube.

20. A method of using the gravity nozzle, the method comprising:
fastening a threaded container valve to a threaded container, wherein the threaded container valve has an inner wall and an outer wall, the inner wall defining a thread profile configured to engage with the threaded container, and wherein the threaded container valve has a first inlet and a second inlet;
affixing a delivery tube to the threaded container valve, wherein the delivery tube includes a cap section with a notch, wherein the notch is configured to be received by a groove on the outer wall of the threaded container valve, and wherein the delivery tube includes a first end of a fluid tube concentrically engaged with the first inlet and a first end of a vapor tube concentrically engaged with the second inlet; and
affixing the delivery tube to a delivery inlet, wherein a second end of the vapor tube is configured concentrically around an outside of a second end of the fluid tube, wherein the second end of the fluid tube concentrically engages with the delivery inlet by extending into the delivery inlet, and wherein the second end of the vapor tube concentrically engages with the delivery inlet by surrounding the delivery inlet, such that
a fluid circuit is formed from the delivery inlet, through the vapor tube, through the second inlet, into the threaded container, through the first inlet, through the fluid tube, and back to the delivery inlet.
